(19) United States
(12) Patent Application Publication
(10) Pub. No.: US 2008/0191425 A1
(43) Pub. Date: Aug. 14, 2008

(54) Planar Seal

(76) Inventors: Martin Gasch, Hilden (DE); Markus Heilig, Betzdorf (DE); Ralf Flemming, Langenbach (DE)

Correspondence Address: Robert L. Stearns;Dickinson Wright PLLC, 38525 Woodward AV, Suite 2000, Bloomfield Hills, MI, 48304, US

(21) Appl. No.: 11/909,523

(22) PCT Filed: Feb. 2, 2006
(86) PCT No.: PCT/DE2006/000151

§ 371 Date: Sep. 24, 2007

(30) Foreign Application Priority Data
Mar. 23, 2005 (DE) 10 2005 013 417.3

(51) Int. Cl. F02F 11/00

(52) U.S. Cl. 277/593

(57) ABSTRACT

The invention relates to a planar seal, in particular, a cylinder head gasket for an internal combustion engine, comprising several through openings, and several media through openings, whereby a web with at least one bead is formed between individual through openings and at least one stopper element is provided radially adjacent to the bead, for each through opening. A through drilling is provided in the web region, through the bead for the passage of media.

The invention relates to a flat seal, in particular a cylinder head seal for an internal combustion engine.

Flat seals, in particular cylinder head seals, comprise a multiplicity of openings, for example combustion chamber through openings, bolt and media through holes. If media through holes, in particular holes through which coolant is conducted, are to be provided in confined regions, for example in the bridge region between two combustion chamber through openings, special measures must be taken on the seal side in order to be able to achieve this.

A further difficulty is that in the bridge region, which is already confined, beads, in particular full beads, are also provided in that region in many cases, in combination with stopper elements adjacent to them, so that special structural measures have to be taken on the seal side. It must also be borne in mind that additional media openings must not impair the operation of the gas seal.

EP-A 05 79 353 discloses a metal seal that can be used as a cylinder head seal for an internal combustion engine that has a plurality of combustion chamber through openings. Furthermore, a number of bolt and medical through holes are provided. This publication relates to the structural design of the bead guide in the region between the combustion chamber through openings.

U.S. Pat. No. 4,861,047 describes a metal plate that can be used as a cylinder head seal which has a structure similar to that described in the document already mentioned. The subject matter of this publication is the particular design of beads running into each other in the region of rectangularly shaped openings provided outside the combustion chamber through openings for the purpose of passing through rods or the like.

The object of the invention is to provide a flat seal, in particular a cylinder head seal for an internal combustion engine, in which even in confined regions which are provided with beads, media through openings can be provided without this having adverse effect on the gas sealing, for example.

This object is achieved by a flat seal according to the features of Claim 1.

Advantageous further developments of the object of the invention may be deduced from the dependent claims.

The object of the invention now makes it possible, even in confined bridge regions provided with beads, to introduce media guiding through holes without this having an adverse effect on the gas sealing.

One embodiment of the invention provides that the through hole is at least partially surrounded by a half-bead, the bead designed as a full bead running into the half-bead.

A further embodiment provides for the partial widening of the full bead in the confined bridge region at predeterminable points, so that a widened region is formed in which an opening is then introduced. This measure ensures that the gas sealing is not impaired, provided that the flat seal is designed as a cylinder head seal.

One- or multi-layer flat seals may be used for the application concerned. To achieve the desired effect it is merely necessary to carry out suitable modifications in those regions where the engine predetermines a bridge cooling, e.g. by widening the full bead to meet the requirements of the particular application.

The object of the invention is represented in the drawing with reference to an exemplary embodiment, and is described as follows.

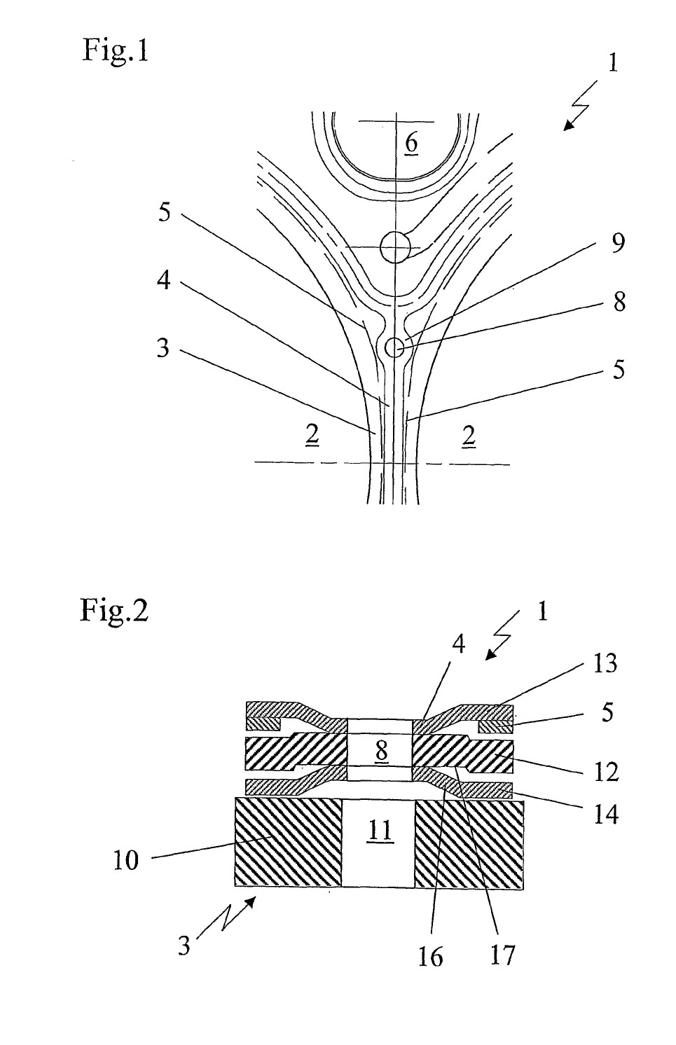

FIG. 1 shows a partial view of a flat seal that can be used as a cylinder head seal,

in elevation, for use in engines with bridge cooling;

FIG. 2 shows a cross-section through the region shown in FIG. 1, on the bridge side.

FIG. 3 shows a partial view of a flat seal that is an alternative to FIG. 1.

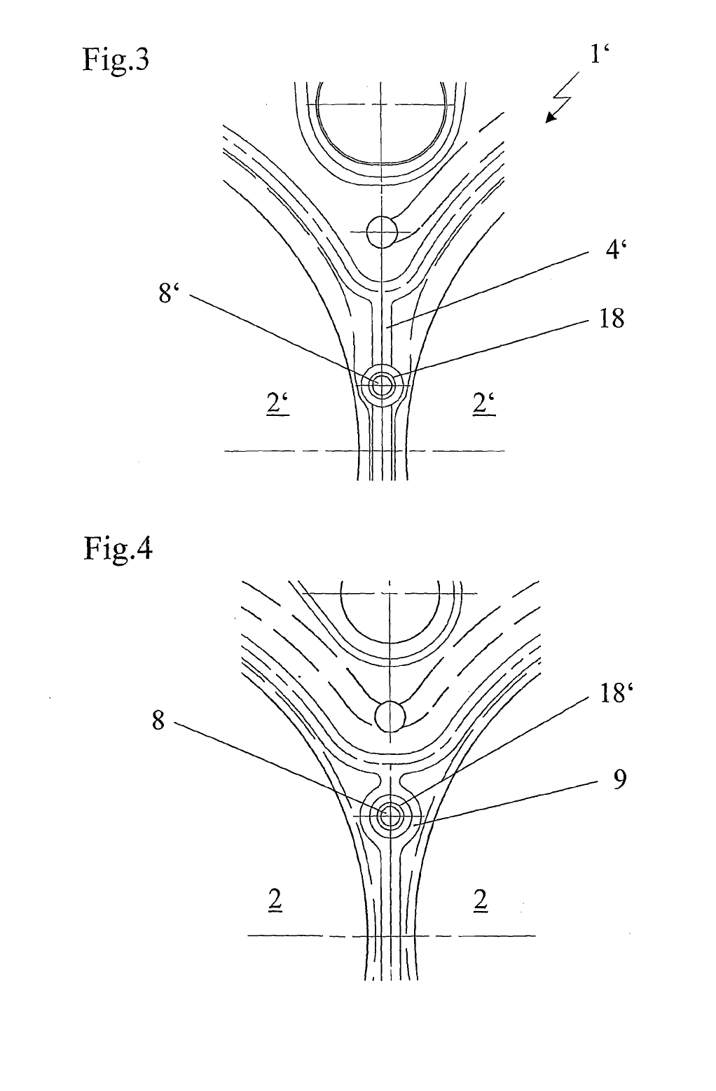

FIG. 4 shows a partial view of a flat seal that is an alternative to FIG. 1.

FIG. 1 shows a partial view of a multi-layer cylinder head seal 1, and in particular the part on the bridge side between two through openings 2 designed as combustion chamber through openings. The bridge formed between through openings 2 is denoted by reference number 3. In this example one layer of flat seal 1 has a full bead 4 in the region of bridge 3, wherein stopper elements 5 are arranged in this embodiment on the left and right adjacent to full bead 4. Only one media through hole 6 is indicated. Now if a further media through hole is now to be provided in the region of bridge 3 for an engine equipped with a bridge cooling system, the following measures are carried out according to the invention: to produce a media through hole 8 a full bead 4 with a widened region 9 is formed. Media through hole 8 already discussed is then introduced in widened region 9.

FIG. 2 shows the cross-section through FIG. 1 on the bridge side. A partial region of engine block 10, specifically bridge 3 provided between combustion chamber through openings 2, which incorporates a water guide region 11, can be seen. Cylinder head seal 1 will have three layers 12, 13, 14 in this region, an intermediate layer 12 being actively connected to stopper elements 5 already discussed. In widened region 9 the media through hole 8 is subsequently introduced. Layers 13, 14 are designed with beads, 4, 4′, 16. Media through hole 8 is produced after all layers 12-14 have been aligned to each other, so that uniform media through guidance through all layers 12-14 is provided. As a result of this measure media through openings 8 for media through guidance may be introduced, even in confined regions, without impairing the gas sealing.

FIG. 3 shows, as an alternative to FIG. 1, a flat seal that can be used as a cylinder head seal 1′, and here too only the part on the bridge side between two combustion chamber through openings 2′ is represented. In a similar manner to FIG. 1, a media through hole 8′ will also be provided here for the through water guidance. Unlike FIG. 1, FIG. 3 shows regions of half beads 18, which partially enclose media through hole 8′. Full bead 4′ runs into the region of the half bead 18 in this example.

FIG. 4 shows an alternative design of media through hole 8. A half bead 18′ is arranged in widened region 9. The sealing is improved still further by the half bead.

1. A flat seal, for an internal combustion engine, comprising at least one metal layer with a full bead and a plurality of through openings, as well as media through holes, wherein a bridge is formed between individual through openings, and wherein at least one media through hole, penetrating the full bead, is introduced in bridge region for guiding the media through.

2. The flat seal according to claim 1, wherein at least one stopper element assigned to each through opening is provided radially adjacent to the full bead.

3. The flat seal according to claim 1, wherein the media through hole is surrounded by a half bead.

4. The flat seal according to claim 1, wherein the full bead runs into the half bead.

5. The flat seal according to claim 1, wherein the full bead is partially widened, and in that the media through hole is introduced in widened area.

6. The flat seal according to claim 1, wherein media through holes are arranged in both end regions of the bridge.

7. The flat seal according to claim 1, comprising a multi-layer structure wherein at least one said full bead is introduced in said at least one layer on the bridge side, which full bead is also provided with a widened region on the medium through guidance side.

8. The flat seal according to claim 7, wherein the full beads are directed toward an intermediate layer.

9. The flat seal according to claim 8, wherein the intermediate layer has a curvature.
